(19) United States
(12) Patent Application Publication
(10) Pub. No.: US 2007/0117572 A1
(43) Pub. Date: May 24, 2007

(54) Efficient Location and Tracking of Mobile Subscribers

(75) Inventors: Thomas Bruce Watson Adam, Edinburgh (GB); Ian Malcolm Atkinson, Edinburgh (GB); Michael Joseph Dixon, Edinburgh (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: TOMTOM INTERNATIONAL B.V., Amsterdam (NL)

(21) Appl. No.: 11/561,530

(22) Filed: Nov. 20, 2006

(30) Foreign Application Priority Data
Nov. 18, 2005 (GB) 0523513.0

(51) Int. Cl. H04Q 7/20

(52) U.S. Cl. 455/456.1

(57) ABSTRACT

A method for locating and tracking devices in a mobile telephone network compries the steps of (a) receiving mobile telephone control parameters in a subscriber database; and (b) using one or more location parameter databases (LPDBs), each mapping control parameters to a geographic location and returning a location result when queried. One or more filters is applied to the control parameters that is received by the subscriber database, each filter selectively initiating processing using a LPDB appropriate to the task of the filter and to the current state of the device.

### BACKGROUND OF THE INVENTION

1. Field of the Invention

This invention relates to a method for and to an apparatus for efficiently locating and tracking devices in a mobile telephone network, and implicitly the subscribers carrying them, as and when they appear to the network.

2. Description of the Prior Art

In a mobile phone system, subscribers carry handsets. When the subscriber initiates or receives a call or text message or data session, radio communication takes place between the handset and a base transceiver station (BTS), the familiar mast on the modern landscape. As well as transmitting an encoding of the message passing between caller and call recipient, the handset and BTS transmit a large amount of control information between themselves for the purposes of reliably and efficiently supporting the communication; for example the system must choose when to pass the call to another BTS as the subscriber moves about. The control information in a Global System for Mobile Communications (GSM) system contains information on the signal strength of neighbouring BTSes, timing advance information to instruct handsets further from the BTS to transmit earlier in order to match their time slot, transmission error rates and much more. Other technologies, such as code division multiple access (CDMA), use different information to achieve the same purposes of reliable and efficient communication. Collectively we refer to these parameters as the mobile phone control parameters.

Mobile Phone System

A location parameter database (LPDB) correlates mobile phone control parameters with geographical locations of handsets. LPDBs can be constructed and maintained by one of several means, and can map one of several useful subsets of control parameters to geographical locations. We provide several examples of LPDBs which have different accuracy, processing costs and completeness of geographical coverage.

Mobile Subscriber Location Database

The mobile subscriber location database is the database through which location queries are serviced. It consists of a subscriber database, and a number of location parameters databases. The location parameters databases are controlled by a database manager.

Subscriber Database

The subscriber database contains raw records of mobile subscriber parameters, derived from the control information passing between the subscriber and the network. These records are kept for all subscribers, and provide the information required to satisfy a query for the subscriber's location, if that should be made. The cost of maintaining the subscriber database is low, because the records it holds do not need to be processed in any way unless and until the location of the relevant subscriber is queried.

Location Parameters Database(s)

A location parameters database (LPDB) maps a subset of the control parameters to a form of geographical location within a geographical area. The location database may contain one or more LPDBs. The choice of which LPDBs to maintain in a location database can depend at least upon the geographical parameters of the area, the computer processing power available to each location query, the network topology and the available mobile phone network control information. The coordinate system used by the LPDB and the encoding within the LPDB of the appropriate mobile phone control parameters are particular to the LPDB. The LPDB translates locations to a form usable by the rest of the system on output. One such form is a map polygon.

Accuracy and cost values are associated with each LPDB in the location database. These allow the location database to select how to carry out each location query. We describe some examples of LPDBs next.

Radio Frequency (RF) Level LPDB

The control information for GSM handsets contains the signal strength observed at the handset for the serving BTS, and up to 6 neighbouring BTSes. The signal strength varies according to distance from the BTS, the topography of the area, the presence of buildings and for many other factors. In the RF Level LPDB, the geographical area is subdivided into regular, small squares, called ‘buckets’. For each bucket, the RF level LPDB maintains a profile of the expected signal strength values received from the visible BTSes. On a location query the bucket which best matches the signal strength profile last recorded for the subscriber's phone the location of which is being queried, is selected as the bucket within which the subscriber is located.

Pairwise Ratio LPDB

In a mobile network, it is now very common for 3 BTSes to be co-located at a single site, with each oriented to provide service to a 120 degree sector of the surrounding area. Then the ratio of RF signal strength observed by a handset from any pair of the BTSes is constant with the distance from the BTSes along a given radial direction, and is strongly dependent on the bearing of the phone from the BTSes. Consequently, if a pair of co-located BTSes at one site, and another pair of BTSes co-located at a site physically separate from the first pair are both visible to a phone, the phone's location can be accurately derived, such as by triangulation.

In this case, the LPDB consists of encodings of the function of RF ratio against bearing for all colocated pairs of BTSes. On a location query, ratios are calculated for the last RF levels observed by the handset. Bearings are looked up using the functions in the LPDB, and 2 bearings are triangulated to derive the location of the handset. Where 2 sets of co-located BTS pairs are visible to a mobile device, the triangulation provides a very precise location. Where we do not have 2 sets of co-located BTS pairs, no location reading is possible. Consequently, this LPDB sometimes needs to be complemented by another more uniform database, but it is highly accurate in areas of good mobile phone coverage.

Cell, Timing Advance LPDB

In a GSM mobile phone network, the cell serving an active handset is always known. In addition, control information is passed to the phone to tell it the timing advance (TA) slot to use when transmitting. This allows the phone to compensate for transmission delays between itself and the BTS, and is implicitly a coarse-grained encoding of the distance between the BTS and the phone. The radius of a single TA slot is about 550 m. In the case of a BTS which serves a 360° radius, this restricts the location of the phone to somewhere in a doughnut shaped area, the actual area of which varies with the TA value. In the increasingly common case where a BTS serves only a 120° sector, the location is restricted to one third of the doughnut. An important factor of the (cell, TA) method is that the conversion from (cell, TA) to location can be rapid. In particular there are few enough (cell, TA) pairs, that the resulting polygon for each can be stored in a lookup table.

Cell-only LPDB

An even coarser grain of LPDB is one that returns locations based only on the serving cell. Techniques can be used to estimate the maximum range of a cell in practice, which may well be much lower than the theoretical range of cells. The radius of the resulting circle is consequently reduced, and is thus useful enough for many location applications.

### SUMMARY OF THE INVENTION

A first aspect is a method for locating and tracking devices in a mobile telephone network comprising the steps of:
(a) receiving mobile telephone control parameters in a subscriber database;
(b) using one or more location parameter databases (LPDBs), each mapping control parameters to a geographic location and returning a location result when queried;
wherein one or more filters is applied to the control parameters that is received by the subscriber database, each filter selectively initiating processing using a LPDB appropriate to the task of the filter and to the current state of the device.

For at least one location parameter database, a filter may determine whether the location parameter database is supplied with control parameters. A filter can also observes changes in control parameters for a given subscriber or for members of a group of subscribers. These control parameters may relate to a particular geographical area of interest, using the lowest cost location parameter database.

A filter may choose an appropriate location parameter database that offers the lowest computational cost. For a particular request, a location mechanism can also be chosen which has the least processing cost, but which can be expected to return a result of the necessary accuracy.

A filter may choose an appropriate location parameter database depending on whether a trigger condition is met; a trigger condition can relate to a subscriber entering a defined area. A trigger condition may relate to a subscriber leaving a defined area. If a trigger condition is met, then the filter causes an appropriate location parameter database to be supplied with control parameters and to return a geographic location of the associated subscriber. If a trigger condition is not met, then the filter re-calculates after a time period that is a function of the estimated speed of the subscriber. The information from one location fix can be used to restrict the possible locations of the next fix.

A filter can invoke retrospective processing on stored subscriber database contents to discover where a subscriber entering a geographical area originated. A filter can invoke retrospective processing on stored subscriber database contents to discover the history of a subscriber's activity.

Additional LPDBs with different cost trade-offs can be added to provide the system with more options. When there is only partial coverage, the next higher accuracy LPDB is selected, or the most accurate lower accuracy LPDB available is selected. High accuracy tracking can be achieved using an initial (cell, timing-advance) LPDB to identify candidate buckets in an RF LPDB.

An origin trigger can be triggered when a subscriber, or a member of a set of subscribers, leaves a defined geographical area, where the origin trigger is implemented using filters. A destination trigger is triggered when a subscriber, or a member of a set of subscribers, enters a defined geographical area, where the destination trigger is implemented using filters. Proximity triggers monitor whether two subscribers are near to each another.

A group of subscribers can be defined automatically as the subscribers in a particular area at a particular time. When some members of the group appear in proximity once again, or enter another area with similar characteristics to the first area, the appropriate triggers will be invoked. A contact tree is generated using call records to discover the set of call recipients for a particular handset, or the set of callers to a particular handset.

The method can be used to determine the presence of a vehicle in a congestion zone; the presence of a vehicle in road toll system or in a road usage pricing system; the usage of vehicles on roads for insurance pricing; to locate and track mobile subscribers for governmental, regulatory and law enforcement purposes; to track vehicles in a fleet.

A second aspect is apparatus which locates and tracks devices in a mobile telephone network comprising:
(a) a subscriber database which receives mobile telephone control parameters;
(b) one or more location parameter databases, each mapping control parameters to a geographic location and returning a location result when queried;

wherein one or more filters is applied to the stream of control parameters that is received by the subscriber database, each filter selectively initiating processing using a LPDB appropriate to the task of the filter and to the current state of the device.

### BRIEF DESCRIPTION OF THE DRAWINGS

FIG. 1 is an example of a configuration of apparatus which can be used in an implementation of the invention.

FIG. 2 is an example of a configuration of apparatus which can be used in an implementation of the invention.

FIG. 3 is an example of location tracking.

FIG. 4 is an example of how improved accuracy may be obtained while location tracking.

FIG. 5 is an example of the case of origin triggering.

FIG. 6 is an example of the case of destination triggering.

FIG. 7 is an example of the case of the proximity of multiple subscribers.

### DETAILED DESCRIPTION

This invention relates to a method and apparatus for efficiently locating and tracking devices in a mobile telephone network, and implicitly the subscribers carrying them, as and when they appear to the network. The mechanism for efficient bulk location is detailed in one implementation. The concepts of tracking and triggering are introduced, and the family of efficient tracking and triggering mechanisms is described.

The system processes control parameters of mobile telephone subscribers' handsets as they are observed on the monitored mobile telephone network, and stores the parameters within a subscriber database. Updated control parameters continuously flow into the subscriber database as they are observed on the network. Some control parameters implicitly encode the location of the handset, for instance and most straightforwardly, the handset is almost always within a few kilometres of the serving cell base station.

One or more location parameter databases (LPDBs) are constructed and maintained. Each LPDB encapsulates a transformation from a subset of the handset control parameters to geographical locations. For instance, there may be a serving cell LPDB. As location requests for particular mobile devices are received or generated, the stored parameters in the subscriber database are referred to and processed by a selected LPDB to generate location fixes with which to respond to the location requests.

In addition to building up LPDBs in order to passively react to any location request, active filters can be attached to the stream of updated control parameters flowing into the subscriber database. These filters can be configured to perform a variety of location-oriented functions: for instance, they can monitor particular geographical areas for activity, or watch for activity by particular subscribers, as identified by the subscriber and equipment identifiers. Possible subscriber and equipment identifier numbers include those for the Mobile Station Integrated Services Digital Network (MSISDN), the International Mobile Subscriber Identity (IMSI), and the International Mobile Equipment Identity (IMEI). The filters can also be configured to notify external clients of the activities they discover, and they can trigger internal components to carry out further processing of the information they pass, for example a filter could invoke some retrospective processing to discover where a subscriber entering a geographical area originated.

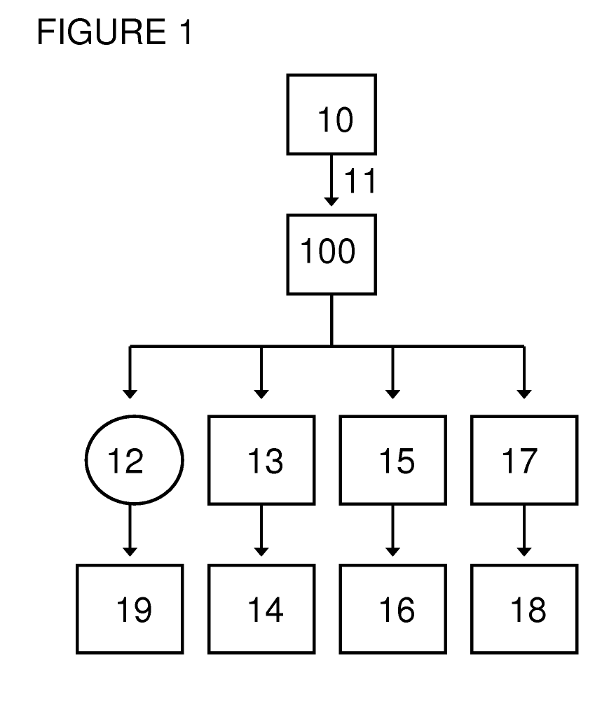

An implementation of the invention is shown in FIG. 1. A mobile phone 10 transmits control parameters 11 to BTS 100. The control parameters are stored in the subscriber database 12. One or more location parameter databases 19 are constructed and maintained using data from the subscriber database 12. Each LPDB 19 encapsulates a transformation from a subset of the handset control parameters to geographical locations. Active filters 13, 15 and 17 can be attached to the stream of updated control parameters flowing into the subscriber database. These filters can be configured to perform a variety of location-oriented functions: for instance, they can monitor particular geographical areas for activity, or watch for activity by particular subscribers, as identified by the subscriber and equipment identifiers. LPDB 14 is constructed based on the parameter data passed by filter 13. LPDB 16 is constructed based on the parameter data passed by filter 15. LPDB 18 is constructed based on the parameter data passed by filter 17.

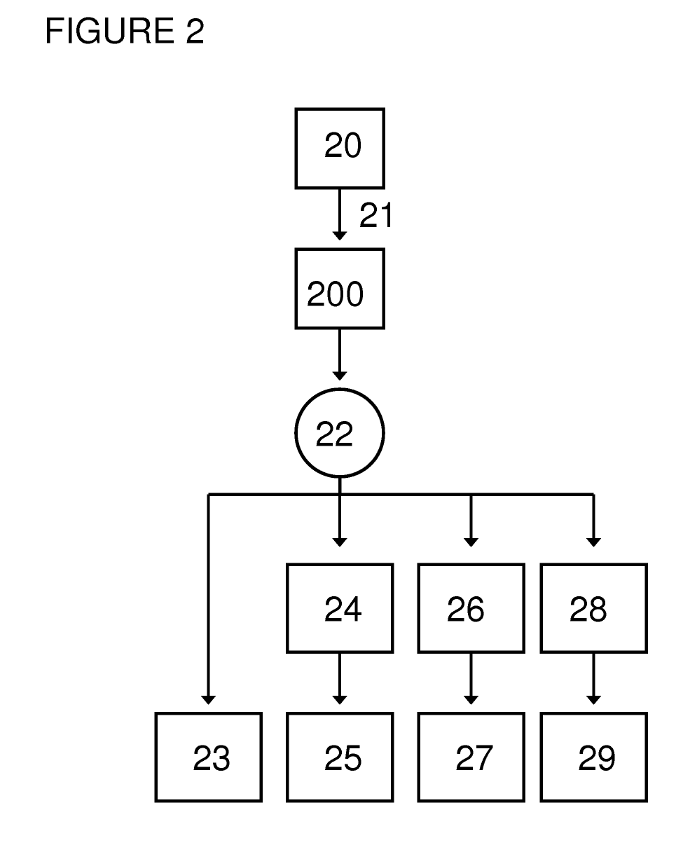

A further implementation of the invention is shown in FIG. 2. A mobile phone 20 transmits control parameters 21 to BTS 200. The control parameters are stored in the subscriber database 22. One or more location parameter databases 23 are constructed and maintained using data from the subscriber database 22. Each LPDB 23 encapsulates a transformation from a subset of the handset control parameters to geographical locations. Active filters 24, 26 and 28 can be attached to the stream of updated control parameters which may be obtained from the subscriber database 22. These filters can be configured to perform a variety of location-oriented functions: for instance, they can monitor particular geographical areas for activity, or watch for activity by particular subscribers, as identified by the subscriber and equipment identifiers. LPDB 25 is constructed based on the parameter data passed by filter 24. LPDB 27 is constructed based on the parameter data passed by filter 26. LPDB 29 is constructed based on the parameter data passed by filter 28.

Those skilled in the art will appreciate that it is possible to create further implementations of the invention which incorporate aspects of the implementations of the invention shown in FIGS. 1 and 2.

The method of storing raw parameters until they are required by a LPDB is particularly efficient because it requires no processing of information related to a particular subscriber, unless and until some form of location information is required for that subscriber. Instead, the unprocessed control parameters are retained until they are made obsolete, and are processed only if and when a location service is applied to that subscriber. This also has the advantage that no commitment needs to be made about which subscribers to place under location mode at any time. All subscribers are potentially locatable, and if the need suddenly arises to locate any individual subscriber, this can be done.

Efficiency is also achieved by structuring the forms of location service so that low processing cost operations are frequently sufficient to satisfy them. It is orders of magnitude cheaper to locate a handset by the serving cell, for which the accuracy is a few kilometers, rather than by RF level, for which the accuracy is in the low hundreds of metres. Any location request can be considered to have the required accuracy, whether it is expressed explicitly or implicitly. The required accuracy can vary greatly. For a particular request the location mechanism is chosen which has the least processing cost, but which can be expected to return a result of the necessary accuracy. In this way, many location requests turn out to be of low cost, and the system can support a much higher overall rate of requests than would otherwise be the case. Each maintained LPDB contributes its own location mechanism, and new LPDBs with different cost trade-offs can be added to provide the system with yet more options.

Motivation

In mobile communication systems, the ability to locate and to track mobile subscribers is extremely important for governmental, regulatory and law enforcement agencies, and is also an enabler of significant business opportunities. In emergency situations, the ability to immediately and automatically locate the caller of an emergency service can save lives. A taxi company would like to track all its taxis so that it can efficiently allocate the closest available taxi when a customer requests one. A local business might run a promotion by text messaging everyone who comes in range of their premises with the details of a special offer. A police force may enforce a legal order restricting a person to remain at or near their home by triggering when that person's phone moves outside the home area. A subscriber, or a group of subscribers, may only become of interest when they enter or leave a particular area. In this case, a trigger can be fired to notify the interested party that the subscriber(s) have arrived or departed.

The method of the invention makes use of the available LPDBs in order to best optimize the location requests it receives. Although our examples are specific to GSM parameters, the same principles clearly apply to the parameters associated with other technologies, and appropriate LPDBs can be constructed for mobile phone systems using these technologies. In the mechanisms we describe for tracking and triggering, low-resolution locations such as those provided by cell-only LPDB can be accurate enough at many stages of the tracking and triggering process.

Location Querying

For a straightforward location query, the accuracy needs to be expressed within the query. The location database selects the lowest cost LPDB with sufficient accuracy, and forwards the query to that LPDB. In the normal course of events, the selected LPDB returns a location result. If that is not possible, as in the case where the LPDB has only partial coverage, the next higher accuracy LPDB is selected. If no such LPDB exists, a lower accuracy LPDB can be queried in order to produce a result which may at least be of some use.

Location Tracking

Where the system is requested to monitor subscribers and/or areas for particular conditions, the flexibility of multiple complementary LPDBs is particularly clear. The tracking mechanism is the means by which the system supports monitoring the path followed by all members of a set of subscribers, or by any individual subscriber. Clearly a user of the system who wishes to track a particular subscriber could simply repeatedly query for the location of the subscriber at the accuracy they require. However, this would be wasteful of resources, particularly if the subscriber is not actually moving.

Track Notification

When tracking a subscriber, the system reports the subscriber's location, calculated at the user-specified accuracy, whenever a subscriber has moved a certain user-specified distance from the last-reported location. Track triggers achieve their efficiency using filters. When the filter observes a new set of parameters for a subscriber, it needs to establish whether the subscriber may be approaching the specified distance from their last-reported location. In the usual case, this can be achieved by a low-cost, low-accuracy LPDB. If it is determined at this stage that the track notification condition is not fulfilled, no further processing is required in the filter.

Safe Time

After deciding that the track notification condition is not fulfilled, the filter can be set to carry out no further processing for an amount of time in the future. The system estimates an upper bound for how fast subscribers can travel, and uses this to calculate the minimum amount of time it could take the subscriber to move far enough to satisfy the notification condition. For example, the upper bound could be 80 miles per hour, if high speed motorway driving is possible, or it could be 40 miles per hour if only driving in urban areas is possible. Then the system need not make another location calculation for the subscriber until the time interval has expired. Parameters for the subscriber will of course still be recorded in the LPDBs as they arrive, as they would for any subscriber, in order to satisfy any future ad-hoc location query.

The next low-accuracy LPDB query will only need to be carried out when new parameters arrive after the safe time interval has been exceeded. Only if the low-accuracy LPDB is unable to determine definitively whether or not the subscriber has satisfied the track notification condition does a higher accuracy LPDB need to be used. If it is determined that the condition for a further track notification has been fulfilled at this point, then the subscriber's location can be notified at the required accuracy.

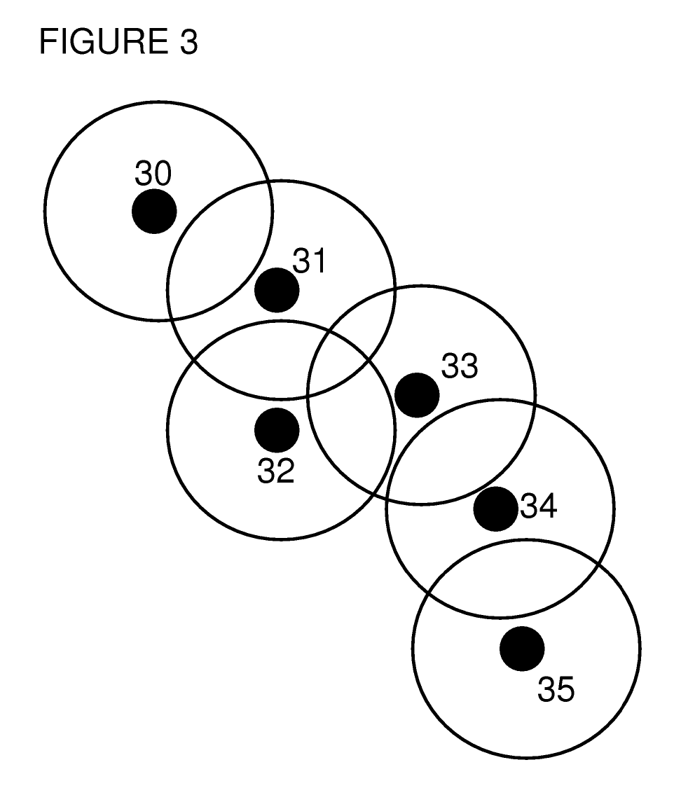

In FIG. 3 we see how as the subscriber has traveled along a complicated path, a track notification will have been made at each of 6 locations along that path. The locations in order are the solid black circles indicated at 30, 31, 32, 33, 34, and 35. The non-filled circles are circles centred on a solid black circle, with the non-filled circle radius being given by the maximum speed multiplied by the safe time. The points 30, 31, 32, 33, 34, and 35 are the only points along the path where full location requests of the accuracy required by the client were required. If the trip had taken the subscriber 30 minutes of time, polling location at 30 s intervals would have required 60 location requests rather than the 6 required using our tracking mechanism.

Accuracy Improvements in Tracking

The accuracy of location fixes during tracking can be improved at little cost, because subsequent location requests are not truly independent; the information from one fix can restrict the possible locations of the next fix. This is illustrated in the following example.

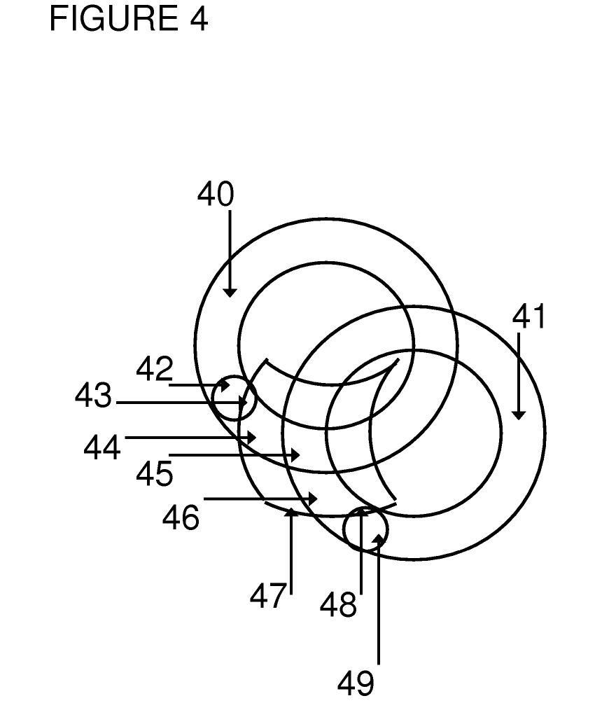

Consider a case where tracking is required to be of high accuracy, and in fact the high accuracy LPDB uses an initial (cell, timing-advance) LPDB to identify candidate buckets in an RF LPDB. An example is given in FIG. 4. At time t1, the (cell, TA) LPDB fix, which we call (cell1, TA1), locates the subscriber to be between the two circles given by area 40. Using an RF and (cell, TA) fix at time t1, the subscriber is located within circle 42. At time t2, the (cell, TA) LPDB fix, which we call (cell2, TA2), locates the subscriber to be between the two circles given by area 41. Using an RF and (cell, TA) fix at time t2, the subscriber is located within circle 49. FIG. 4 shows that the subscriber has moved from circle 42 at t1 to circle 49 at t2. But the tracking filter also observes that there has been a handover of the subscriber from (cell1, TA1) to (cell2, TA2) at a time t3, in area 45. By using the time difference t3 minus t1, and a sensible maximum movement speed for the subscriber, we find that at t1 the subscriber must have been located in area 44. Since we also know that the subscriber was in circle 42 at t1, the position of the subscriber at t1 is therefore narrowed down to the intersection of 42 and 44, which is small area 43. This result can be reported. Also, by using the time difference t2 minus t3, and a sensible maximum movement speed for the subscriber, we find that at t2 the subscriber must have been located in area 46. Since we also know that the subscriber was in circle 49 at t2, the position of the subscriber at t2 is therefore narrowed down to the intersection of 46 and 49, which is small area 48. This result can be reported. The area 47 bounded by the four curved sides is the possible area in which the subscriber could have been between t1 and t2, based on the subscriber having been in area 45 at time t3.

Location Triggering

The location triggering mechanism shares many of the efficiency techniques used in location tracking. In particular the safe time mechanism is used to restrict the query rate internal to the system while guaranteeing that triggers will be fired in a timely manner when the appropriate condition is satisfied.

Origin/Destination Triggers

Origin and Destination triggers are similar to each other. An origin trigger is a trigger which fires when a subscriber (or a member of a set of subscribers) leaves a defined geographical area. A destination trigger is a trigger which fires when a subscriber (or a member of a set of subscribers) enters a defined geographical area. Although in the most general case a destination trigger could be an origin trigger using the complement of the area, the distinction is important because the most usual case concerns respectively entering or leaving an area defined by a low-order polygon; most often the area of interest is an area in the region of a point of interest.

Origin and destination triggers are implemented by filters. When the filter observes a new set of parameters for a subscriber in the relevant set, it needs to establish whether the subscriber is approaching the borders of the area, from the outside for destination triggers and from the inside for origin triggers.

Origin Trigger

In the origin trigger case the system defines the safe area in the co-ordinate space of a low-cost, low-accuracy LPDB. The safe area may be as simple as the set of serving cells which are entirely contained in the origin area. The product of the size of the safe area and the cost of a location query in the LPDB provides a sum cost for using the particular LPDB for the area. We can select the lowest cost LPDB by this metric to provide the first filter for the cage trigger. Where the filter receives new parameters and immediately determines that the subscriber is in the safe area according to the low cost LPDB, it can complete processing. As in the case with track notifications, the position within the safe area is used to generate a safe time interval in addition to the location result. This safe time is attached to the filter, which avoids its carrying out any further location queries for the duration of the time interval. If the filter cannot determine that the subscriber is in a safe area using a low-cost LPDB, it may actually determine that the subscriber has left the trigger area, and that the trigger should be fired to notify the client. It is more likely however that the filter will need to carry out a further query using a more precise, and higher cost, LPDB. When a precise enough LPDB is used, the determination will be made that the subscriber has left the trigger area, or the subscriber will be given a new (albeit small) safe area and a new (albeit short) safe timer.

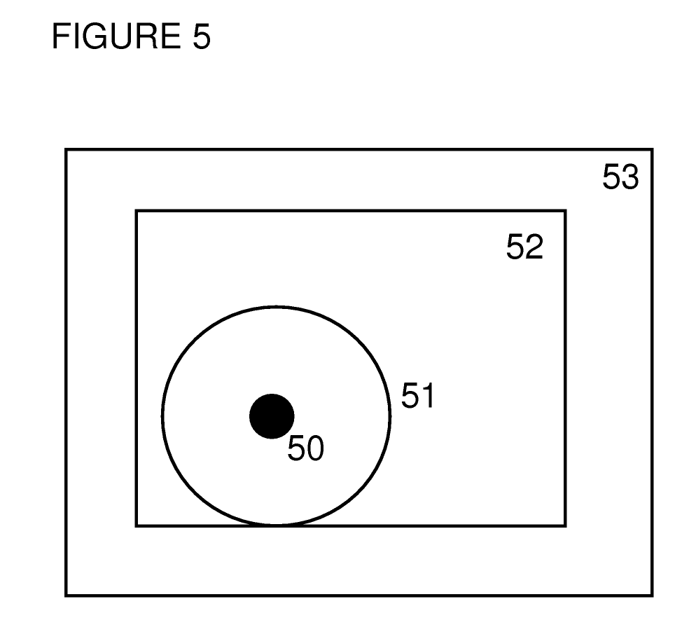

FIG. 5 shows a subscriber 50 within the origin trigger area 53. Rectangular area 52 is defined as the safe area. Circle 51 is centred on subscriber 50. Circle 51 has a radius such that the radius is the minimum distance from subscriber 50 to the edge of the safe area 52. A safe time can then be defined which is the radius of 51 divided by the maximum speed of the subscriber 50. During the safe time, no more location processing is required for the subscriber.

Destination

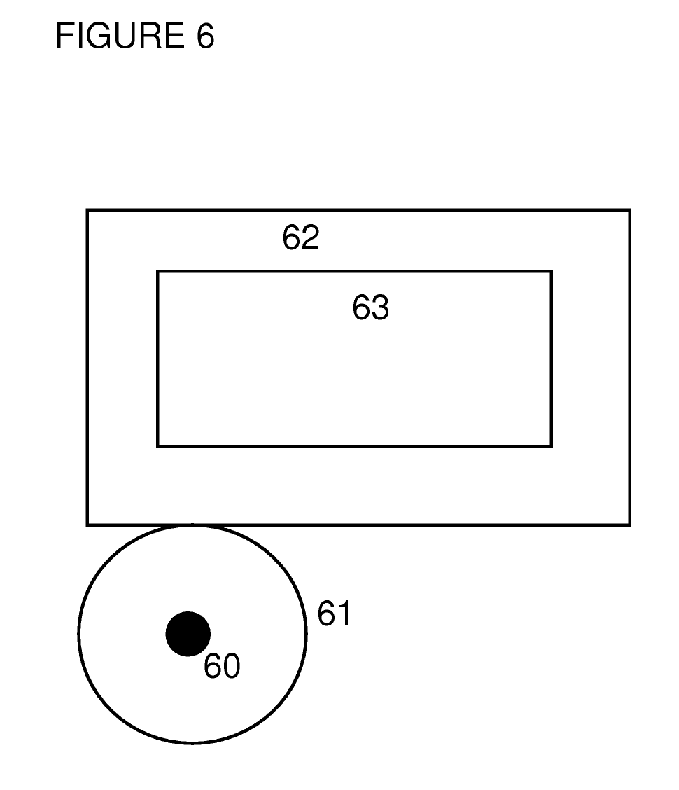

Destination triggers are monitored in an analogous way to origin triggers. In the destination case, an unsafe area is defined using a low-cost LPDB which contains the destination trigger area. A safe timer is defined based on the minimum time in which the subscriber could reach the unsafe area. When the safe timer expires the location of the subscriber is calculated, lowest cost LPDB first, until a sufficient1y accurate result is obtained to set up a new unsafe area and safe timer, or to report that the destination area has been entered. FIG. 6 shows an example of a destination trigger, in which an unsafe area 62 and safe timer for a subscriber 60 are being monitored. Destination trigger area 63 is defined and unsafe area 62 is defined. Subscriber 60 is outside the unsafe area 62. The circle 61 is centred on subscriber 60 and has a radius given by the shortest distance from the subscriber 60 to the unsafe area 62. The safe time is defined as this radius divided by the maximum speed.

Proximity Triggers

Proximity triggers monitor whether two given subscribers are near to one another. Proximity can be triggered for a discrete pair of subscribers, or for any pair in a set of subscribers. In tracking the proximity of a discrete pair of subscribers, the concept of safe time can again be used. On establishing with a low-accuracy LPDB that the pair is sufficiently separated, a timer is set according to the maximum possible closing speed. The safe time may be defined as the distance between the subscribers divided by the maximum closing speed of either subscriber, multiplied by ½. The factor of ½ arises because the two subscribers could approach each other at the maximum closing speed relative to the surface of the Earth. For the duration of this timer, no location queries are required for either subscriber, at least for the purposes of the proximity of this pair. When the timer has expired, the process can be repeated. Only when the subscribers are sufficiently close must a high accuracy LPDB be used.

Where the proximity of any pair of subscribers from a set of subscribers should cause a trigger event, a more sophisticated variation is used. Rather than test the proximity of every permutation of pairs, the system defines safe areas for each subscriber, based upon the current location of that subscriber. The safe area expands the area around the subscriber as far as possible, consistent with a safe time for any of the other members of the subscriber set to reach it. Then the safe area of each subscriber can be treated in the same way as an origin trigger for that subscriber, for the period of the safe time. The process of generating the safe area for each member of the set of subscribers is itself amenable to efficient choice of LPDB, and is given as follows. Each subscriber is located with a low cost LPDB. The closest possible distances between each pair are calculated. A safe area for each subscriber is defined using this calculation. Where a subscriber has a sufficiently large safe area according to the low-cost LPDB, the subscriber need not be considered further in establishing safe areas. The remaining subscribers are located using higher accuracy LPDBs in order to generate a large enough safe area for each subscriber, or to notify the client of the trigger if subscribers are within sufficient proximity. All the subscribers' safe timers are started. When a safe timer is completed, a new safe timer is recalculated for the subscriber based on how long we can guarantee that the subscriber will remain in their safe area. When a subscriber leaves their safe area, a new safe area is calculated for them based on the minimum distances from the current safe areas of the other members of the set of subscribers in question.

The mechanism can be modified to iteratively update the safe areas of neighbouring subscribers where this is necessary to allow each subscriber a large enough safe area that no processing need be done. The situation we achieve is that once the proximity trigger has been set up the only significant processing costs are spent on subscribers that are very close to coming into contact with other subscribers.

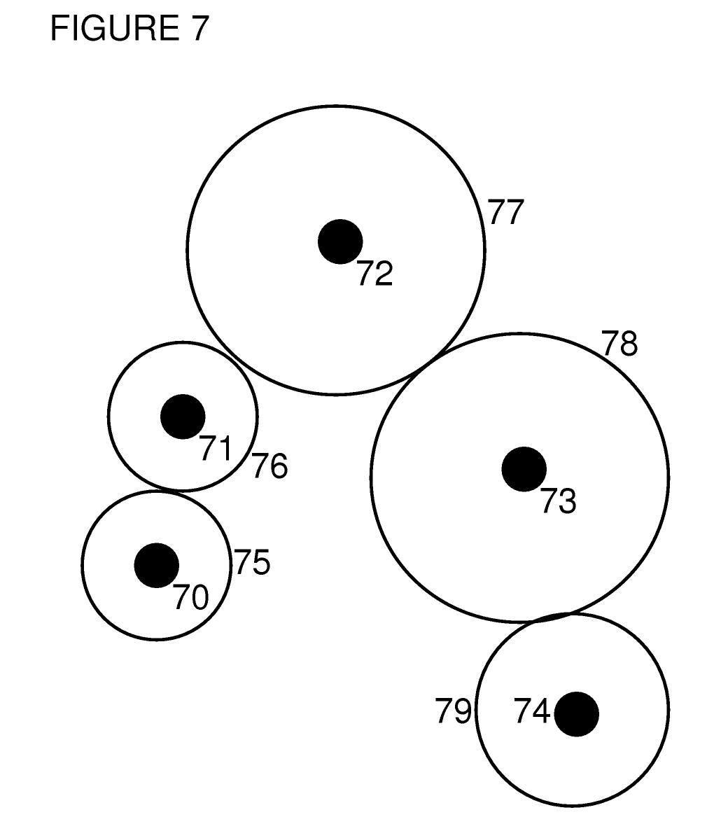

FIG. 7 shows multiple subscribers 70, 71, 72, 73 and 74 being monitored, with respective safe areas bounded by circles 75, 76, 77, 78 and 79. It is clear that different subscribers are being monitored with different safe areas, and therefore there are different safe timers. The two subscribers closest together, subscribers 70 and 71, have necessarily been assigned the smallest safe areas, and will therefore require the highest amount of location processing to verify whether they come into sufficiently close proximity. Subscribers 72, 73 and 74 need only be checked again after a much longer time delay because they are not current1y close to any other subscriber in the set.

Defining Groups of Subscribers Automatically

Tracking and the various forms of triggers allow the monitoring of groups of subscribers. These groups can be defined manually, but they can also be defined as the subscribers which satisfy a particular historical location condition. We can define a group as the subscribers in a particular area at a particular time, knowing that that group contains everyone who might be of interest in the system user's context. When some members of the group appear in proximity once again, or enter another area with similar characteristics to the first area, the appropriate triggers will be invoked. Without automatic groups, the client would have to explicitly record the subscribers satisfying an original request, and then feed those back into a subsequent request.

Historical Analysis

Some location-based services require the retention of historical information, because the location request may refer to a time in the past, and the subject (eg. the subscriber) is not known until a later time. In this case, the system has no option but to retain historical information for as long as it may be required for analysis. For example, if a law enforcement agency identifies criminal activity in the past as evidence comes to light, they may, subject to controls, wish to analyse the mobile phone history of someone who has become a suspect in the light of that evidence.

In general, any kind of tracking or triggering analysis may only become interesting in retrospect. But to accomplish this, a complete history of every subscriber must be retained for as long as the time interval between behaviour and suspicion, which may be years. The problem can be addressed by the system described, given sufficient data storage capacity. No processing is required on any preserved data until it becomes the subject of a historical analysis. Unprocessed control parameters can simply be stored, and the system can be run with saved data for the date in question and replayed as fresh input data when a historical interval becomes interesting.

Contact Tree Tracking

A particular instance of historical analysis is the generation of a contact tree. The principle is to use call records to discover the set of call recipients for a particular handset, or callers to a particular handset. We can identify contacts of a handset who are the callers to the handset, the call recipients from the handset, the Short Message Service (SMS) senders to that handset, or the SMS recipients from that handset.

As other forms of interaction via the handset are developed, these can also be used to determine contacts whenever the contact has an identifying number which is transmitted in the network control information. It is then possible to identify the closure of contact sets. Suppose for example that A called B, B called C, C called D, X called Y, and Y text-messaged A. Therefore if A is interesting, so too are B, C, D, X and Y. However, it is possible for contact analysis to be thwarted by the process of using multiple separate handsets, such as anonymous, pay-as-you-go handsets. However if A calls B on B's first handset, and B calls C on B's second handset, then both of B's handsets have most likely been in physical proximity immediately or very soon after A called B; therefore the system incorporates the facility to generate contact trees over proximities as well as direct calling relationships. Suppose for example A calls B on B's first handset, and another handset in proximity to B's first handset calls C. Let us assume that the other handset is B's second handset. From this we derive the contact set A, B's first handset, B's second handset, and C.

This technique is most useful with complete coverage of all mobile networks in the historical data: then we can ensure that all contacts can be identified. But even with only some networks covered, we can identify proximate contacts within the same network and augment these with call contacts from billing records to build a more extensive contact network for an individual handset than hitherto possible. For example, in the case where a number of anonymous pre-paid mobile phones are bought on the same network, and a contact set for a handset of interest generated from billing information contains one of these handsets, proximate contacts within the monitored network may identify other pre-paid handsets which can then be analysed for contacts to extend the contact set of the original handset.

Relative Proximity

In the case where two handsets are on the same mobile network, the system can very efficiently and accurately generate the candidate handsets which are very close to the first handset. Although the physical location generated may have a degree of error, the handsets will be observed to have many control parameters which are close to identical. We can configure the system with the set of parameters which behave this way. Then close proximity can be assessed by comparing the raw parameters, without the expensive step of translating them to a location with a high-accuracy LPDB.

In the case where two handsets are on different mobile networks, some aspects of relative proximity may be used, because there are cases where different networks share BTS sites. In general, however, a set of possibly close handsets will be calculated using a low cost LPDB, and for those possibly close handsets in the set, a high accuracy location request will be made to determine accurate proximity.

Various modifications and alterations of this invention will become apparent to those skilled in the art without departing from the scope of this invention, and it should be understood that this invention is not to be unduly limited to the illustrative embodiments set forth herein.

1. Method for locating and tracking devices in a mobile telephone network comprising the steps of:
(a) receiving mobile telephone control parameters in a subscriber database;
(b) using one or more location parameter databases (LPDBs), each mapping control parameters to a geographic location and returning a location result when queried;
wherein one or more filters is applied to the control parameters that is received by the subscriber database, each filter selectively initiating processing using a LPDB appropriate to the task of the filter and to the current state of the device.

2. The method of claim 1 wherein for at least one location parameter database a filter determines whether the location parameter database is supplied with control parameters.

3. The method of claim 1, wherein a filter observes changes in control parameters for a given subscriber or for members of a group of subscribers.

4. The method of claim 3, wherein a filter observes control parameters which relate to a particular geographical area of interest, using the lowest cost location parameter database.

5. The method of claim 1, wherein a filter chooses an appropriate location parameter database depending on whether a trigger condition is met.

6. The method of claim 1, wherein a filter chooses the location parameter database that offers the lowest computational cost.

7. The method of claim 1, wherein for a particular request, a location mechanism is chosen which has the least processing cost, but which can be expected to return a result of the necessary accuracy.

8. The method of claim 5 wherein a trigger condition relates to a subscriber entering a defined area.

9. The method of claim 5, wherein a trigger condition relates to a subscriber leaving a defined area.

10. The method of claim 5, wherein if a trigger condition is not met, then the filter re-calculates after a time period that is a function of the estimated speed of the subscriber.

11. The method of claim 1, wherein the information from one location fix is used to restrict the possible locations of the next fix.

12. The method of claim 5, wherein if a trigger condition is met, then the filter causes an appropriate location parameter database to be supplied with control parameters and to return a geographic location of the associated subscriber.

13. The method of claim 1, wherein a filter invokes retrospective processing on stored subscriber database contents to discover where a subscriber entering a geographical area originated.

14. The method of claim 1, wherein a filter invokes retrospective processing on stored subscriber database contents to discover the history of a subscriber's activity.

15. The method of claim 1, wherein additional LPDBs with different cost trade-offs can be added to provide the system with more options.

16. The method of claim 1, wherein the subscriber database retains control parameter records for all subscribers on a network.

17. The method of claim 1, wherein a location parameter database uses RF levels.

18. The method of claim 1, wherein a location parameter database uses pairwise ratios.

19. The method of claim 1, wherein a location parameter database uses cell timing advance.

20. The method of claim 1, wherein a location parameter database uses cell identity.

21. The method of claim 1 wherein a location parameter database uses GPS trace data fed back from a GPS device used by the subscriber

22. The method of claim 1, wherein when there is only partial coverage, the next higher accuracy LPDB is selected, or the most accurate lower accuracy LPDB available is selected.

23. The method of claim 1, wherein high accuracy tracking is achieved using an initial (cell, timing-advance) LPDB to identify candidate buckets in an RF LPDB.

24. The method of claim 1, wherein an origin trigger is triggered when a subscriber, or a member of a set of subscribers, leaves a defined geographical area, where the origin trigger is implemented using filters.

25. The method of claim 1, wherein a destination trigger is triggered when a subscriber, or a member of a set of subscribers, enters a defined geographical area, where the destination trigger is implemented using filters.

26. The method of claim 1, wherein proximity triggers monitor whether two subscribers are near to each another.

27. The method of claim 1, wherein a group of subscribers is defined automatically as the subscribers in a particular area at a particular time.

28. The method of claim 27, wherein when some members of the group appear in proximity once again, or enter another area with similar characteristics to the first area, the appropriate triggers will be invoked.

29. The method of claim 1, wherein a contact tree is generated using call records to discover the set of call recipients for a particular handset, or the set of callers to a particular handset.

30. The method of claim 1, wherein the method is used to determine the presence of a vehicle in a congestion zone.

31. The method of claim 1, wherein the method is used to determine the presence of a vehicle in road toll system or in a road usage pricing system.

32. The method of claim 1, wherein the method is used to determine the usage of vehicles on roads for insurance pricing.

33. The method of claim 1, wherein the method is used to locate and track mobile subscribers for governmental, regulatory and law enforcement purposes.

34. The method of claim 1, wherein the method is used to track vehicles in a fleet

35. Apparatus which locates and tracks devices in a mobile telephone network comprising:
(a) a subscriber database which receives mobile telephone control parameters;
(b) one or more location parameter databases, each mapping control parameters to a geographic location and returning a location result when queried;
wherein one or more filters is applied to the stream of control parameters that is received by the subscriber database, each filter selectively initiating processing using a LPDB appropriate to the task of the filter and to the current state of the device.
